(19) United States
(12) Patent Application Publication
(10) Pub. No.: US 2018/0043617 A1
(43) Pub. Date: Feb. 15, 2018

(54) 3-D PRINTING SURFACE

(71) Applicant: 3M Innovative Properties Company, St. Paul, MN (US)

(72) Inventors: Naota SUGIYAMA, Tokyo (JP); Jiro HATTORI, Kanagawa (JP); Anna KIKUCHIHARA, Kanagawa (JP); Takehiro MITSUDA, Kanagawa (JP)

(21) Appl. No.: 15/552,515

(22) PCT Filed: Feb. 5, 2016
(86) PCT No.: PCT/US2016/016765

§ 371 Date: Aug. 22, 2017

Related U.S. Application Data
(60) Provisional application No. 62/120,065, filed on Feb. 24, 2015.

(51) Int. Cl. B29C 64/245; B33Y 70/00; B33Y 10/00; B29C 64/118; B29C 64/30

(52) U.S. Cl. CPC B29C 64/245; B29C 64/118; B29C 64/30; B33Y 10/00; B33Y 70/00; B29K 2067/046

(57) ABSTRACT

Method of three-dimensionally printing an article onto a surface comprising a composition, the composition comprising: a binder and a mixture. The mixture comprises nanoparticles in at least two groupings of size ranges.

### CROSS REFERENCE TO RELATED APPLICATION

This application claims the benefit of U.S. Provisional Patent Application No. 62/120,065, filed Feb. 24, 2015, the disclosure of which is incorporated by reference herein in its entirety.

### BACKGROUND

Three-dimensional (“3-D”) printing technology is known in the art (see, e.g., U.S. Pat. No. 5,939,008 (Comb et al.)) and offers cost advantages and higher speed of making some articles (including prototype models) compared, for example, to conventional molding processes. In some forms of 3-D printing (e.g., that are available, for example, under the trade designation “MAKER BOT AND 3-D SYSTEMS” from Stratasys, Eden Prairie, Minn.), a plastic is extruded through a nozzle that traces a part's cross sectional geometry layer by layer. The build material is often supplied in filament form. The nozzle contains heaters that keep the plastic at a temperature just above its melting point, so that it flows easily through the nozzle and forms the layer. The temperature of molten plastics immediately drops and the viscosity increases after flowing from the nozzle and bonds to the layer below. In the starting point, the surface that the part is printed onto is often relatively cold so that the molten plastics from the extruder tip immediately harden and often do not stick well to the (initial) printing surface. An alternative approach is to have the surface that the part is printed onto be relatively hot to aid in the deposited material sticking to the surface, but issues have been encountered in the article undesirably shrinking during cooling, as well as difficulty removing some printed articles from the printing surface.

Another approach is to mechanically contain the first writing of molten plastic by using a structured platform with the printing surface and has been found to have some effectiveness in limiting delamination of the printed article from the printing surface due to thermal shrinkage. A drawback of this approach, however, is the holding power due to heat accumulation and undesirable thermal shrinkage, as well as the surface or texture imparted by the structured platform.

Also, undesired is the useful life of the printing surfaces from the approaches discussed above is typically limited.

Alternative 3-D printing surfaces are desired that preferably address one or more of the undesirable aspects of the surfaces or approaches discussed above.

### SUMMARY

In one aspect, the present disclosure provides a method of three-dimensionally (3-D) printing an article, the method comprising:

providing a surface comprising a composition, the composition comprising:
(i) a binder, and
(ii) a mixture of nanoparticles in a range from 80 wt. % to 99.9 wt. % (in some embodiments, 85 wt. % to 95 wt. %), based on the total weight of the composition, wherein 10 wt. % to 50 wt. % of the nanoparticles have an average particle diameter in a range from 2 nm to 200 nm and 50 wt. % to 90 wt. % of the nanoparticles have an average particle diameter in a range from 60 nm to 400 nm, and wherein the ratio of average particle diameters of nanoparticles having an average particle diameter in the range from 2 nm to 200 nm to average particle diameters of nanoparticles having an average particle diameter in the range from 60 nm to 400 nm is in a range from 1:1 to 1:200; and

three-dimensionally printing the article onto the surface. Typically, the surface is the surface of a layer (e.g., a film).

### BRIEF DESCRIPTION OF THE DRAWINGS

FIG. 1 is a graph that depicts the simulation result between the combination of the particle size (larger particles group/smaller particles group), and the weight ratio of the smaller particles group and the larger particles group.

FIG. 2A is schematic of a 3-D printing apparatus with an article printed on exemplary surface described herein.

FIG. 2B is a schematic of the exemplary 3-D printing apparatus shown in FIG. 2A.

FIG. 3 is schematic of a computer-aided designed (CAD) article to be 3-D printed.

### DETAILED DESCRIPTION

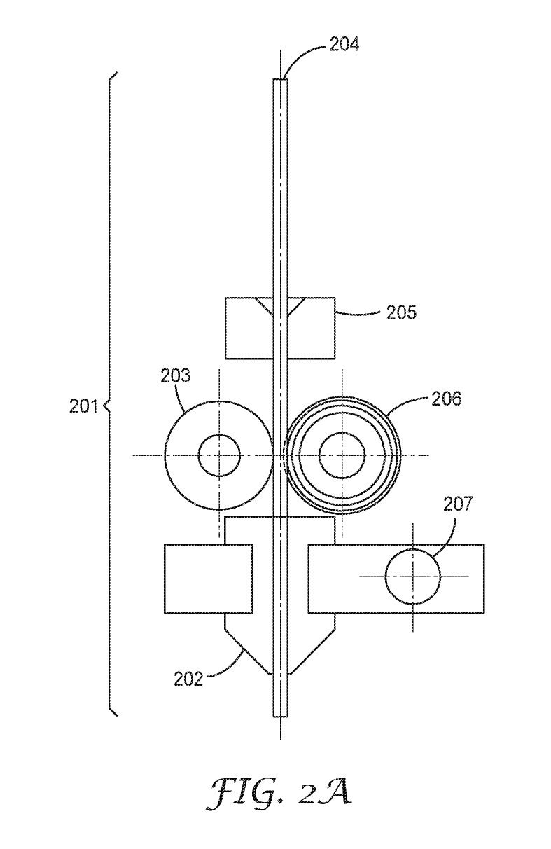

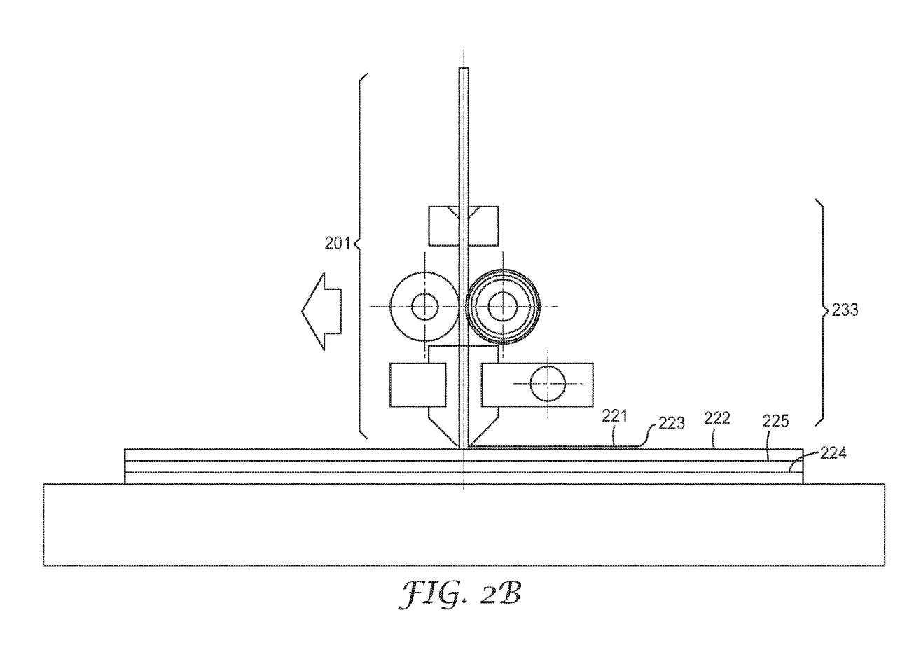

Referring to FIGS. 2A and 2B 3-D printing apparatus 201 with article 221 printed on exemplary surface 222. Exemplary conventional 3-D printer 201 prints polymer layer 221 on major surface described herein 222 of layer 223 secured to substrate 225 with adhesive 224. 3-D printing apparatus 201 has extruder die 202, filament guide die 205, filament feeding gear 206, polymer filament 204, heater 207, and backup roll 203.

Exemplary binders include resin obtained by polymerizing curable monomers/oligomers or sol-gel glass. More specific examples of resins include acrylic resins, urethane resins, epoxy resin, phenol resin, and polyvinyl alcohol. Further, curable monomers or oligomers may be selected from curable monomers or oligomers known in the art. In some embodiments, the resins include dipentaerythritol pentaacrylate (available, for example, under the trade designation “SR399” from Arkema Group, Clear Lake, Tex.), pentaerythritol triacrylate isophorone diisocyanate (IPDI) (available, for example, under the trade designation “UX5000” from Nippon Kayaku Co., Ltd., Tokyo, Japan), urethane acrylate (available, for example, under the trade designations “UV1700B” from Nippon Synthetic Chemical Industry Co., Ltd., Osaka, Japan; and “UB6300B” from Nippon Synthetic Chemical Industry Co., Ltd., Osaka, Japan), trimethyl hexane di-isocyanate/3ydroxyl ethyl acrylate (TMHDI/HEA, available, for example, under the trade designation “EB4858” from Daicel Cytech Company, Ltd., Tokyo, Japan), polyethylene oxide (PEO) modified bis-A diacrylate (available, for example, under the trade designation “R551” from Nippon Kayaku Co., Ltd., Tokyo, Japan), PEO modified bis-A epoxyacrylate (available, for example, under the trade designation “3002M” from Kyoeishia Chemical Co., Ltd., Osaka, Japan), silane based UV curable resin (available, for example, under the trade designation “SK501M” from Nagase ChemteX Corporation, Osaka, Japan), and 2-phenoxyethyl methacrylate (available, for example, under the trade designation “SR340” from Arkema Group); and the mixture thereof. Use, for example, in the range from about 1.25 wt. % to about 20 wt. % of 2-phenoxyethyl methacrylate may improve adhesion to polycarbonate. Use of di-functional resins (e.g., PEO modified bis-A diacrylate (“R551”) and trimethyl hexane di-isocyanate/4ydroxyl ethyl acrylate (TMHDI/HEA) (available, for example, under the trade designation “EB4858” from Daicel Cytech Company Ltd.)) may simultaneously improve the hardness, impact resistance, and flexibility of the composition of the surface (typically in the form of a layer exhibiting the surface). In some embodiments, it may be desirable to use curable monomers or oligomers capable of forming three-dimensional structure. In some embodiments, binder is provided by curing a reactive resin (e.g., a radical reactive acrylate).

In some embodiments, the binder is provided from a mixture comprising in a range from 80 wt. % to 90 wt. % radical reactive acrylate and 20 wt. % to 10 wt. % of non-radical reactive resin, based on the total weight of the mixture. Examples of radical reactive acrylate include aliphatic urethane (available, for example, under the trade designation “EBECRYL 8701” from Daicel-Allnex, Ltd., Tokyo, Japan). Examples of non-radical reactive resin include methyl methacrylate copolymer (available, for example, under the trade designation “B44” from Dow Chemical Company, Midland, Mich.). Examples of non-radical reactive resin include cellulose acetate butyrate (available, for example, under the trade designation “CAB 381-20” from Eastman Chemical Company, Kingsport, Tenn.).

Optionally, the composition precursor further comprises crosslinking agents. Exemplary crosslinking agents include poly (meth)acryl monomers selected from the group consisting of (a) di(meth)acryl containing compounds such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, tripropylene glycol diacrylate; (b) tri(meth)acryl containing compounds such as glycerol triacrylate, trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, tris(2-hydroxyethyl)isocyanurate triacrylate; (c) higher functionality (meth)acryl containing compounds such as ditrimethylolpropane tetraacrylate, dipentaerythritol pentaacrylate, ethoxylated (4) pentaerythritol tetraacrylate, pentaerythritol tetraacrylate, caprolactone modified dipentaerythritol hexaacrylate; (d) oligomeric (meth)acryl compounds (e.g., urethane acrylates, polyester acrylates, epoxy acrylates; polyacrylamide analogues of the foregoing; and combinations thereof). Such materials are commercially available, including at least some that are available, for example, Arkema Group, Clear Lake, Tex.; UCB Chemicals Corporation, Smyrna, Ga.; and Aldrich Chemical Company, Milwaukee, Wis. Other useful (meth) acrylate materials include hydantoin moiety-containing poly (meth) acrylates, for example, as reported in U.S. Pat. No. 4,262,072 (Wendling et al.).

In some embodiments, a crosslinking agent comprises at least three (meth) acrylate functional groups (commercially available, for example, from Daicel-Allnex, Ltd., Tokyo, Japan; including hexafunctional aliphatic urethane acrylate, available, for example, under the trade designation “EBECRYL8301” and trifunctional aliphatic urethane acrylate, available under the trade designation “EBECRYL8701”), and tris (2-hydroxy ethyl) isocyanurate triacrylate (available, for example, under the trade designation “SR368” from Arkema Group, Clear Lake, Tex.). Further, mixtures of multifunctional and lower functional acrylates, such as a mixture of trifunctional aliphatic urethane acrylate and 1,6-hexanediol diacrylate may also be utilized. These exemplary crosslinking agents may be used as the curable monomers or oligomers.

In some embodiments, the mixture of nanoparticles present in the composition of the surface is in a range from 80 wt. % to 99.9 wt. % (in some embodiments, 85 wt. % to 95 wt. %), based on the total weight of the composition of the surface (typically in the form of a layer exhibiting the surface). The mixture of the nanoparticles includes 10 wt. % to 50 wt. % of the nanoparticles have an average particle diameter in a range from 2 nm to 200 nm (smaller particles group) and 50 wt. % to 90 wt. % of the nanoparticles have an average particle diameter in a range from 60 nm to 400 nm (larger particles group).

The average diameter of nanoparticles is measured with transmission electron microscopy (TEM) using commonly employed techniques in the art. For measuring the average particle size of nanoparticles, sol samples can be prepared for TEM imaging by placing a drop of the sol sample onto a 400 mesh copper TEM grid with an ultra-thin carbon substrate on top of a mesh of lacey carbon (available from Ted Pella Inc., Redding, Calif.). Part of the drop can be removed by touching the side or bottom of the grid with filter paper. The remainder can be allowed to dry. This allows the particles to rest on the ultra-thin carbon substrate and to be imaged with the least interference from a substrate. Then, TEM images can be recorded at multiple locations across the grid. Enough images are recorded to allow sizing of 500 to 1000 particles. The average diameters of the nanoparticles can then be calculated based on the particle size measurements of each sample. TEM images can be obtained using a high resolution transmission electron microscope (available under the trade designation “Hitachi H-9000” from Hitachi, Tokyo, Japan) operating at 300 KV (with a LaB₆ source). Images can be recorded using a camera (e.g., Model No. 895, 2 k×2 k chip available under the trade designation “GATAN ULTRASCAN CCD” from Gatan, Inc., Pleasanton, Calif.). Images can be taken at a magnification of 50,000× and 100,000×. For some samples, images may be taken at a magnification of 300,000×.

Typically, the nanoparticles are inorganic particles. Examples of the inorganic particles include metal oxides such as alumina, tin oxides, antimony oxides, silica (SiO, SiO₂), zirconia, titania, ferrite, mixtures thereof, or mixed oxides thereof; metal vanadates, metal tungstates, metal phosphates, metal nitrates, metal sulphates, and metal carbides.

As used herein “smaller particles group” means nanoparticles having an average particle diameter in the range from 2 nm to 200 nm, and “larger particles group” means nanoparticles having an average particle diameter in the range from 60 nm to 400 nm.

The average particle diameter of the smaller particles group is in the range from 2 nm to 200 nm. In some embodiments, it may be from 2 nm to 150 nm, 3 nm to 120 nm, or even 5 nm to 100 nm. The average particle diameter of the larger particles group is in the range from 60 nm to 400 nm (in some embodiments, it may be from 65 nm to 350 nm, 70 nm to 300 nm, or even 75 nm to 200 nm).

The mixture of nanoparticles includes at least two different size distributions of nanoparticles. Other than the size distribution, the nanoparticles may be the same or different (e.g., compositional, including surface modified or unmodified). In some embodiments, the ratio of average particle diameters of nanoparticles having an average particle diameter in the range from 2 nm to 200 nm to average particle diameters of nanoparticles having an average particle diameter in the range from 60 nm to 400 nm is in a range from 50 to 50, 35 to 65, or even 0.5 to 99.5. Exemplary combinations of the particle sizes include the combination of 5 nm/190 nm, 5 nm/75 nm, 20 nm/190 nm, 5 nm/20 nm, 20 nm/75 nm, and 75 nm/190 nm. By using the mixture of different sized nanoparticles, larger amount of nanoparticles can be added to the composition of the surface (typically in the form of a layer exhibiting the surface).

Further, selection, for example, of various types, amounts, sizes, and ratios of particles may affect the transparency (including haze) and hardness. In some embodiments relatively high desired transparency and hardness can be obtained in the same composition of the surface (typically in the form of a layer exhibiting the surface).

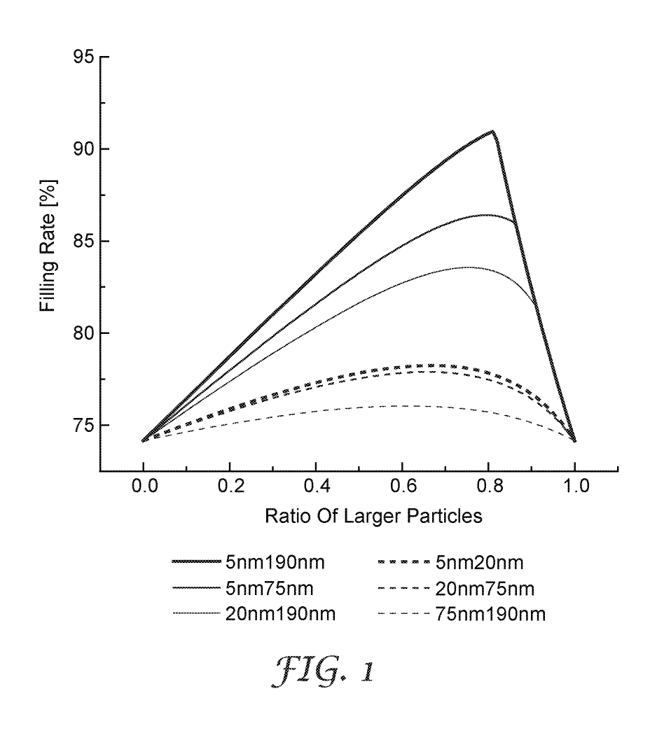

The weight ratio (%) of the smaller particles group and the larger particles group can be selected depending on the particle size used or the combination of the particle size used. In some embodiments, the weight ratio can be also selected depending on the particle size used or the combination of the particle size used. For example, it may be selected from simulation between the combination of the particle size (larger particles group/smaller particles group), and the weight ratio of the smaller particles group and the larger particles group with software obtained under the trade designation “CALVOLD 2” (see also “Verification of a Model for Estimating the Void Fraction in a Three-Component Randomly Packed Bed,” M. Suzuki and T. Oshima: Powder Technol., 43, 147-153 (1985)). The simulation examples are shown in the FIG. 1. From the simulation, examples of the preferable combination may be from about 45/55 to about 13/87 or from about 40/60 to about 15/85 for the combination of 5 nm/190 nm; from about 45/55 to about 10/90 or from about 35/65 to about 15/85 for the combination of 5 nm/75 nm; from about 45/55 to about 10/90 for the combination of 20 nm/190 nm; from about 50/50 to about 20/80 for the combination of 5 nm/20 nm; from about 50/50 to about 22/78 for the combination of 20 nm/75 nm; and from about 50/50 to about 27/73 for the combination of 75 nm/190 nm.

In some embodiments, a larger fill amount of nanoparticles can be incorporated into a composition for the surface by using preferable sizes and combinations of the nanoparticles, which may allow tailoring the resulting transparency and hardness of the composition of the surface (typically in the form of a layer exhibiting the surface).

Typically, the thickness of a layer (typically in the form of a film) having the surface for 3-D printing is in a range from thickness less than 100 micrometers (in some embodiments, less than 100 micrometers, 50 micrometers, 10 micrometers, 5 micrometers, 3 micrometers, or even less than 1 micrometers; in some embodiments, in a range from 3 micrometers to 5 micrometers, 2 micrometers to 4 micrometers, or even 1 micrometer to 3 micrometers).

Typically, by using the mixture of different sized nanoparticles, thicker and harder layers can be obtained.

Optionally, the nanoparticles may be modified with a surface treatment agent. In general a surface treatment agent has a first end that will attach to the particle surface (covalently, ionically or through strong physisorption) and a second end that imparts compatibility of the particle with the resin and/or reacts with resin during curing. Examples of surface treatment agents include alcohols, amines, carboxylic acids, sulfonic acids, phosphonic acids, silanes, and titanates. The desired type of treatment agent is determined, in part, by the chemical nature of the nanoparticle surface. Silanes are often preferred for silica and other siliceous fillers. Silanes and carboxylic acids are often preferred for metal oxides. The surface modification can be done either subsequent to mixing with the monomers or after mixing. When silanes are employed, reaction of the silanes with the nanoparticle surface is often preferred prior to incorporation into the binder. The required amount of surface treatment agent is dependent upon several factors such as particle size, particle type, surface treatment agent molecular weight, and surface treatment agent type. In general, it is often preferred that about a monolayer of surface treatment agent be attached to the surface of the particle. The attachment procedure or reaction conditions required also depend on the surface treatment agent used. When employing silanes, surface treatment at elevated temperatures under acidic or basic conditions for about 1 hour to 24 hours is often preferred. Surface treatment agents such as carboxylic acids do not usually require elevated temperatures or extended time.

Representative embodiments of surface treatment agents include compounds such as isooctyl trimethoxy-silane, N-(3-triethoxysilylpropyl) methoxyethoxyethoxyethyl carbamate, polyalkyleneoxide alkoxysilane (available, for example, under the trade designation “SILQUEST A1230” from Momentive Specialty Chemicals, Inc., Columbus, Ohio), N-(3-triethoxysilylpropyl) methoxyethoxyethoxyethyl carbamate, 3-(methacryloyloxy)propyltrimethoxysilane, 3-(Acryloxypropyl)trimethoxysilane, 3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures thereof.

In some embodiments, the composition of the surface (typically in the form of a layer exhibiting the surface) comprises about 0.1 wt. % to about 20 wt. % (in some embodiments, about 1 wt. % to about 20 wt. %, or even about 5 wt. % to about 15 wt. %) binder, based on the total weight of the composition of surface (typically in the form of a layer exhibiting the surface).

The components of the composition precursor can be combined and processed as is generally known in the art to provide the surface. For example, the following processes may be used. Two or more different sized nanoparticles sol with or without modification are mixed with curable monomers and/or oligomers in solvent with an initiator, which is adjusted to a desired weight % (in solid) by adding the solvent, to furnish a composition precursor. No solvent can be used depending on the curable monomers and/or oligomers used. The composition precursor can be coated onto the substrate by known coating process such as bar coating, dip coating, spin coating, capillary coating, spray coating, gravure coating, or screen printing. After drying, the coated composition (typically in the form of a film) precursor can be cured with known polymerization methods such as ultraviolet (UV) or thermal polymerization.

If the nanoparticles are surface modified, the composition precursor can be made, for example, as follows. Inhibitor and surface modification agent is added to solvent in a vessel (e.g., in a glass jar), and the resulting mixture added to an aqueous solution having the nanoparticles dispersed therein, followed by stirring. The vessel is sealed and placed in an oven, for example, at an elevated temperature (e.g., 80° C.) for several hours (e.g., 16 hours). The water is then removed from the solution by using, for example, a rotary evaporator at elevated temperature (e.g., 60° C.). A solvent is charged into the solution, and then remaining water is removed from the solution by evaporation. It may be desired to repeat the latter a couple of times. The concentration of the nanoparticles can be adjusted to the desired weight % by adjusting the solvent level.

The composition precursor can be prepared by mixing the components of the composition using conventional techniques known in the art. The composition (typically in the form of a layer exhibiting the surface) precursor may further include known additives such as a UV absorbing agent, a UV reflective agent, an anti-fog agent, an antistatic agent, an easy-clean agent such as an anti-finger printing agent, an anti-oil agent, an anti-lint agent, or an anti-smudge agent, or other agents adding an easy-cleaning function.

Optionally, the surface on which 3-D printing is done may be modified to change the surface roughness. Techniques for modifying the surface roughness include plasma enhanced chemical vapor deposition (e.g., oxygen etching process, corona treatment, and ultraviolet radiation).

Techniques for applying the composition of the surface precursor (solution) to the surface of a substrate (typically in the form of a film) are known in the art and include bar coating, dip coating, spin coating, capillary coating, spray coating, gravure coating and screen printing. Exemplary substrates include polyethylene terephthalate (PET), polymethyl methacrylate (PMMA), polycarbonate (PC), polyvinyl chloride (PVC), polypropylene (PP), acrylonitrile butadiene styrene (ABS), polyimide, triacetyl cellulose (TAC), cyclo-olefin polymer (COP), urethane, sheet of paper, glass, aluminum, and stainless steel. The coated composition of the surface precursor can be dried and cured by polymerization methods known in the art, including UV or thermal polymerization.

In some embodiments, the surface (typically in the form of a layer exhibiting the surface) has a [symbol] haze value in range from 0 to 4 as determined by the “Haze Test” in the Examples, below. In some embodiments, the surface (typically in the form of a layer exhibiting the surface) has a less than 100 degree of water contact angle as determined by the “Water Contact Angle” in the Examples, below. In some embodiments, the surface (typically in the form of a layer exhibiting the surface) has a greater than 8 nm of surface roughness as determined by atomic force microscopy described in the Examples, below.

Three-dimensional articles can be 3-D printed onto the surface using techniques known in the art. The surface is typically a surface of a film. The surface typically is in the form of a layer (e.g., film) exhibiting the surface can be attached to substrate using attachment techniques known in the art, including adhesives. In some embodiments, the adhesive can be an adhesive layer on the backside of the layer, which optionally may have a release liner on the adhesive. Optionally, a protective film layer can be provided on the surface for 3-D printing and then removed before use as a 3-D printing surface. Exemplary protective films include those available, for example, under trade designations “HITALEX A1310” or “HITALEX A1320” from Hitachi Chemical Co., Tokyo, Japan, or “TORETE 7111” or “TORETE 7531” from Toray Advanced Film Co., Tokyo, Japan.

In some embodiments, the article has an accuracy rating of not greater than 1 as determined by the “3-D Printing Accuracy Test” in the Examples, below.

### Exemplary Embodiments

1. A method of three-dimensionally printing an article, the method comprising:

providing a surface comprising a composition (typically, the surface is the surface of a layer (e.g., a film)), the composition comprising:
(i) a binder, and
(ii) a mixture of nanoparticles in a range from 80 wt. % to 99.9 wt. %, based on the total weight of the composition, wherein 10 wt. % to 50 wt. % of the nanoparticles have an average particle diameter in a range from 2 nm to 200 nm and 50 wt. % to 90 wt. % of the nanoparticles have an average particle diameter in a range from 60 nm to 400 nm, and wherein the ratio of average particle diameters of nanoparticles having an average particle diameter in the range from 2 nm to 200 nm to average particle diameters of nanoparticles having an average particle diameter in the range from 60 nm to 400 nm is in a range from 1:1 to 1:200; and three-dimensionally printing the article onto the surface.
   2. The method of Exemplary Embodiment 1, wherein the nanoparticles include modified nanoparticles.
   3. The method of either Exemplary Embodiment 1 or 2, wherein the mixture of nanoparticles is in a range of from 85 wt. % to 95 wt. %, based on the total weight of the composition.
   4. The method of any preceding Exemplary Embodiment, wherein the surface has a [symbol] haze value in range from −1.0 to 1.0 as determined by the Haze Test.
   5. The method of any preceding Exemplary Embodiment, wherein the article has an accuracy rating of not greater than 1 as determined by the 3-D Printing Accuracy Test.
   6. The method of any preceding Exemplary Embodiment, wherein the surface has a less than 100 degree of water contact angle.
   7. The method of any preceding Exemplary Embodiment, wherein the surface has a greater than 8 nm of surface roughness as determined by atomic force microscopy.
   8. The method of any preceding Exemplary Embodiment further comprising curing reactive resin to provide the binder.
   9. The method of any of Exemplary Embodiments 1 to 7 further comprising curing radical reactive acrylate to provide the binder.
   10. The method of any of Exemplary Embodiments 1 to 7 further comprising curing a mixture comprising in a range from 80 wt. % to 90 wt. % radical reactive acrylate and 20 wt. % to 10 wt. % of non-radical reactive acrylate, based on the total weight of the mixture, to provide the binder.
   11. The method of any of Exemplary Embodiments 7 to 10, wherein the curing includes actinic radiation.
   12. The method of any preceding Exemplary Embodiment further comprising plasma treating the surface prior to three-dimensionally printing the article onto the surface.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Materials

| Material | Description | Source |
|---|---|---|
| “A-174” | 3-methacryloxypropyl- | obtained from Alfa Aesar, Ward Hill, MA, |
| | trimethoxysilane | under trade designation “SILQUEST A-174” |
| “PROSTAB” | 4-hydroxy-2,2,6,6- | obtained from Aldrich Chemical Company, |
| | tetramethylpiperidine 1- | Milwaukee, WI, under trade designation |
| | oxyl (5 wt. %) | “PROSTAB” |
| “NALCO 2327” | 20 nm diameter SiO₂ sol | obtained from Nalco Company, Naperville, |
| | | IL, under trade designation “NALCO 2327” |
| “NALCO 2329” | 75 nm diameter SiO₂ sol | obtained from Nalco Company under trade |
| | | designation “NALCO 2329” |
| “EBECRYL 8301” | hexafunctional aliphatic | obtained from Daicel-Allnex, Ltd., Tokyo, |
| | urethane acrylate | Japan, under trade designation “EBECRYL |
| | | 8301” |
| “EBECRYL 8701” | trifunctional aliphatic | obtained from Daicel-Allnex, Ltd., under trade |
| | urethane acrylate | designation “EBECRYL 8701” |
| “SR368” | tris (2-hydroxy ethyl) | obtained from Arkema Group, Clear Lake, |
| | isocyanurate triacrylate | TX, under trade designation “SR368” |
| “SR238” | 1,6-hexanediol diacrylate | obtained from Arkema Group, Clear Lake, |
| | | TX, under trade designation “SR238” |
| “PARALOID B-44” | methyl methacrylate | obtained from Eastman Chemical Company, |
| | copolymer | Kingsport, TN, under trade designation |
| | | “PARALOID B-44” |
| “CAB 381-20” | cellulose acetate butyrate | obtained from Eastman Chemical Company |
| | | under trade designation “CAB 381-20” |
| “KY1203” | UV/EB curable fluorinated | obtained from Shin-Etsu Chemical Co., |
| | surfactant | Tokyo, Japan, under trade designation “KY- |
| | | 1203” |
| “TEGORAD 2500” | leveling agent | obtained from Evonik Industries AG, Mobile, |
| | | AL, under trade designation “TEGORAD |
| | | 2500” |
| “ESACURE ONE” | difunctional alpha | obtained from Lamberti, Gallarate, Italy, |
| | hydroxyketone | under trade designation “ESACURE ONE” |
| 1-methoxy-2-propanol | solvent | obtained from Aldrich Chemical Company, |
| | | Milwaukee, WI |
| Methyl isobutyl ketone | solvent | obtained from Aldrich Chemical Company |

### Fabrication of Modeling Article for Evaluation of 3-D Printability

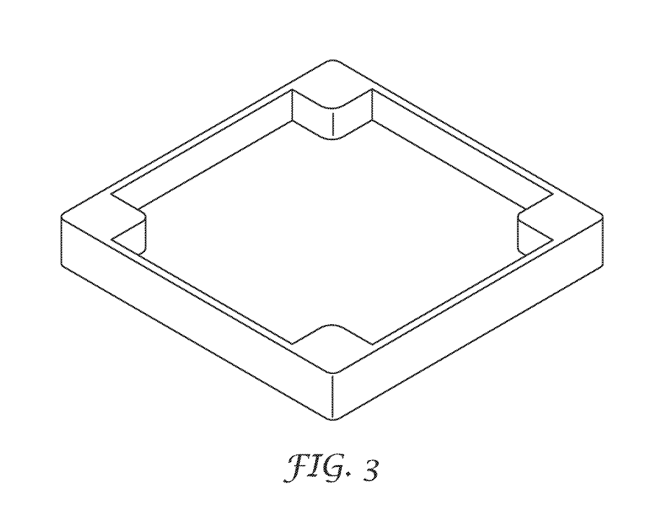

An optically clear adhesive (obtained from 3M Company, St. Paul, Minn., under trade designation “3M OPTICALLY CLEAR LAMINATING ADHESIVE 8172”) was laminated on the back side of a 3-D printing substrate, having a 3-D printing surface on the front side of the substrate prepared according to Examples and Comparative Examples described below, was applied on a 3-D printer stage using a silicon rubber roll. Original model design to be 3-D printed was designed using Computer-Aided Design (CAD) software (obtained under the Trade designation “AUTODESK INVENTOR 2013”). The CAD designed article to be 3-D printed was a square shaped tray having side walls and corners as shown schematically in FIG. 3.

Also, for the EX-3 and EX-5 substrates, a polylactic acid (PLA) filament (1.75 mm diameter; white color; obtained under trade designation “FES-175PLA” from Abbe Corporation, Yokohama, Japan) was used to 3-D print the CAD generated design on the 3-D printing surface using a 3-D printer (obtained under the trade designation “OPENCUBE SCOOVO, MODEL G170” from Opencube, Yokohama, Japan, and software obtained under the trade designation “ULTIMATE CURA” (version 14.03) from Ultimaker BV, Geldermalsen, Netherlands) with the following 3-D printing conditions were:
Layer height: 0.08 mm
Shell thickness: 1.0 mm
Bottom Top thickness: 0.6 mm
Fill density: 30%
Print speed: 52 mm/sec.
Printing temperature 204° C.

Also, for Example 3 (EX-3) and Example 5 (EX-5) substrates, acrylonitrile-butadiene-styrene (ABS) fibers (1.75 mm diameter; white color; obtained under trade designation “3D PRINTER FILAMENT” from Zhejiang Flashforge 3D Technology Co., Ltd., Jinhua, China) were used to 3-D print parts using a 3-D Printer (obtained from under the trade designation “FLASHFORGE DREAMER” from a FlashForgeUSA, Philips Drive, City of Industry, CA). Printing conditions were:

Slice engine: Slic3r
Number of printhead: 2
Print resolution: Intermediate
Layer height: 0.20 mm
First layer height: 0.30 mm
Frame thickness: 3 layer
Packing density: 25%
Filling pattern: line
Print speed: 60 mm/sec.
Head speed: 80 mm/sec.
Head temp: 220° C.
Platform temp: 80° C.
Cooling fan control: auto

Test Methods

### Method for Determining Accuracy of 3-D Printing (“3-D Printing Accuracy Test”)

Accuracy of 3-D printing was evaluated by determining the warpage at each corner of the 3-D printed article and assigning a warpage rating. The warpage was rated as follows:

| Observation | Rating |
|---|---|
| No Warpage at each corner | 0 |
| Warpage at each corner less than 0.1 mm | 1 |
| Warpage at each corner from 0.1 mm to 0.2 mm | 2 |
| Large warpage at each corner ranging from 0.2 mm to 1.0 mm | 3 |
| Article was not fixed on the 3D printing surface | 4 |

Method for Determining Release Ability of Fabricated 3-D Article from the 3-D Printing Surface

Release ability of fabricated 3-D articles from the 3-D printing surfaces were evaluated (i.e., rated) as follows:

Good: Easy release by hand,

Heavy: Difficult to release by hand but possible using a tool,

Article Break: Extremely difficult to release, even using a tool, and article broken.

In addition, after releasing the 3-D printed articles from the 3-D printing surface, presence or absence of delamination of the 3-D printing surface from its substrate was determined by using an optical microscope.

### Method for Determining Adhesion of 3-D Printing Surface on its Substrate

Adhesion of the 3-D printing surface to its substrate for samples prepared according to the Examples and Comparative Examples, was evaluated by cross-cut test according to JIS K5600 (April 1999), the disclosure of which is incorporated herein by reference, where 5×5 grid with 1 mm of interval (i.e., 25 one mm by one mm squares) and tape (obtained under the trade designation “NICHIBAN” from Nitto Denko Co., Ltd., Osaka, Japan) was used.

### Method for Determining Optical Properties

Optical properties such as clarity, haze, and percent transmittance (TT) of the 3-D printing surface samples prepared according to the Examples and Comparative Examples were measured using a haze meter (obtained under the trade designation “NDH5000W” from Nippon Denshoku Industries, Co., Ltd., Tokyo, Japan). Optical properties were determined on as-prepared samples (i.e., initial optical properties) and after subjecting the samples to steel wool abrasion resistance testing. The “Haze Test” compared the difference in haze values before and after subjecting the samples to steel wool abrasion resistance testing.

### Method for Determining Steel Wool Abrasion Resistance (“Haze Test”)

The scratch resistance of the samples prepared according to the Examples and Comparative Examples was evaluated by the surface changes after the steel wool abrasion test using 30 mm diameter #0000 steel wool after 10 cycles at 350 gram load and at 60 cycles/min. rate. The strokes were 85 mm long. The instrument used for the test was an abrasion tester (obtained under the trade designation “IMC-157C” from Imoto Machinery Co., Ltd., Kyoto, Japan). After the steel wool abrasion resistance test was completed, the samples were observed for the presence of scratches and their optical properties (percent transmittance, haze. [symbol] Haze or delta Haze (i.e., haze after abrasion test-initial haze)) were measured again using the method described above. The presence of scratches was rated as follows:

| Observation | Rating |
|---|---|
| No scratches | 0 |
| A few very faint scratches only observed in reflection | 1 |
| Several faint scratches | 2 |
| Several faint scratches and a few deep scratches | 3 |
| Large number of deep scratches easily observed in | 4 |
| reflected or transmitted light. Almost complete | |
| removal of coating. | |

### Method for Determining Water Contact Angle (“Water Contact Angle Test”)

Water contact angle of the 3-D printing surface was measured by sessile drop method using a contact angle meter (obtained under the trade designation “DROPMASTER FACE” from Kyowa Interface Science Co., Ltd., Saitama, Japan). The value of contact angle was calculated from the average of 5 measurements.

### Preparation of Surface Modified Silica Sol (Sol-1)

25.25 grams of A-174 and 0.5 gram of 4-hydroxy-2,2,6,6-tetramethylpiperidine 1-oxyl (5 wt. %; “PROSTAB”) was added to a mixture of 400 grams of 20 nm diameter SiO₂ sol (“NALCO 2327”) and 450 grams of 1-methoxy-2-propanol in a glass jar with stirring at room temperature for 10 minutes. The jar was sealed and placed in an oven at 80° C. for 16 hours. The water was removed from the resultant solution with a rotary evaporator at 60° C. until the solid content of the solution was close to 45 wt. %. 200 grams of 1-methoxy-2-propanol was charged into the resultant solution, and the remaining water was removed by using the rotary evaporator at 60° C. This latter step was repeated for a second time to further remove water from the solution. The concentration of total SiO₂ nanoparticles was then adjusted to 45.5 wt. % by adding 1-methoxy-2-propanol to result in a SiO₂ sol containing surface modified SiO₂ nanoparticles with an average size of 20 nm.

### Preparation of Surface Modified Silica Sol (Sol-2)

5.95 grams of 3-methacryloxypropyl-trimethoxysilane (“A-174”) and 0.5 gram of 4-hydroxy-2,2,6,6-tetramethylpiperidine 1-oxyl (5 wt. %; “PROSTAB”) was added to a mixture of 400 grams of 75 nm diameter SiO₂ sol (“NALCO 2329”) and 450 grams of 1-methoxy-2-propanol in a glass jar with stirring at room temperature for 10 minutes. The jar was sealed and placed in an oven at 80° C. for 16 hours. The water was removed from the resultant solution with a rotary evaporator at 60° C. until the solid content of the solution was close to 45 wt. %. 200 grams of 1-methoxy-2-propanol was charged into the resultant solution, and the remaining water was removed by using the rotary evaporator at 60° C. This latter step was repeated for a second time to further remove water from the solution. The concentration of total SiO₂ nanoparticles was adjusted to 45.5 wt. % by adding 1-methoxy-2-propanol to result in the SiO₂ sol containing surface modified SiO₂ nanoparticles with an average size of 75 nm.

### Preparation of Hardcoat Precursor (HC-1)

32.0 grams of hexafunctional aliphatic urethane acrylate (“EBECERYL 8701”) and 8.0 grams of 1,6-hexanediol diacrylate (“SR238”) were mixed. 1.2 gram of difunctional alpha hydroxyketone

(“ESACURE ONE”) as the photoinitiator and 18.0 grams of methyl isobutyl ketone were then added to the mixture. The mixture was adjusted to 40.0 wt. % in solids by adding 43.8 grams of 1-methoxy-2-propanol, and the hard coat precursor HC-1 was provided.

### Preparation of Hardcoat Precursor (HC-2)

18.46 grams of Sol-1, 34.29 grams of Sol-2, 12.8 grams of hexafunctional aliphatic urethane acrylate (“EBECERYL 8701”) and 3.2 grams of 1,6-hexanediol diacrylate (“SR238”) were mixed. 1.2 gram of difunctional alpha hydroxyketone (“ESACURE ONE”) as the photoinitiator and 18.0 grams of methyl isobutyl ketone were then added to the mixture. The mixture was adjusted to 40.0 wt. % in solids by adding 15.05 grams of 1-methoxy-2-propanol, and the hard coat precursor HC-2 was provided.

### Preparation of Hardcoat Precursor (HC-3)

23.08 grams of Sol-1, 42.86 grams of Sol-2, 8.0 grams of trifunctional aliphatic urethane acrylate (“EBECERYL 8701”) and 2.0 grams of 1,6-hexanediol diacrylate (“SR238”) were mixed. 1.2 grams of difunctional alpha hydroxyketone (“ESACURE ONE”) as the photoinitiator and 18.0 grams of methyl isobutyl ketone were then added to the mixture. The mixture was adjusted to 40.0 wt. % in solids by adding 7.87 grams of 1-methoxy-2-propanol, and the hard coat precursor HC-3 was provided.

### Preparation of Hardcoat Precursor (HC-4)

26.15 grams of Sol-1, 48.57 grams of Sol-2, 4.8 grams of trifunctional aliphatic urethane acrylate (“EBECERYL 8701”) and 1.2 gram of SR238 were mixed. 1.2 gram of difunctional alpha hydroxyketone (“ESACURE ONE”) as the photoinitiator, 0.8 gram of UV/EB curable fluorinated surfactant (“KY1203”), and 18.0 grams of methyl isobutyl ketone were then added to the mixture. The mixture was adjusted to 40.0 wt. % in solids by adding 2.67 grams of 1-methoxy-2-propanol, and the hard coat precursor HC-4 was provided.

### Preparation of Hardcoat Precursor (HC-5)

26.15 grams of Sol-1, 48.57 grams of Sol-2, 4.8 grams of trifunctional aliphatic urethane acrylate (“EBECERYL 8701”) and 1.2 gram of 1,6-hexanediol diacrylate (“SR238”) were mixed. 1.2 gram of difunctional alpha hydroxyketone (“ESACURE ONE”) as the photoinitiator, 0.16 gram of leveling agent (“TEGORAD 2500”), and 18.0 grams of methyl isobutyl ketone were then added to the mixture. The mixture was adjusted to 40.0 wt. % in solids by adding 3.31 grams of 1-methoxy-2-propanol, and the hard coat precursor HC-5 was provided.

### Preparation of Durable Nanoporous Coating Precursor (DNP-1)

26.15 grams of Sol-1, 48.57 grams of Sol-2, and 4.8 grams of trifunctional aliphatic urethane acrylate (“EBECERYL 8701”) and 1.2 gram of 1,6-hexanediol diacrylate (“SR238”) were mixed. 1.2 gram of difunctional alpha hydroxyketone (“ESACURE ONE”) as the photoinitiator and 18.0 grams of methyl isobutyl ketone were then added to the mixture. The mixture was adjusted to 40.0 wt. % in solids by adding 3.07 grams of 1-methoxy-2-propanol and the durable nanoporous coating precursor DNP-1 was provided.

### Preparation of Durable Nanoporous Coating Precursor (DNP-2)

24.62 grams of Sol-1, 45.71 grams of Sol-2, and 6.4 grams tris (2-hydroxy ethyl) isocyanurate triacrylate (“SR368”) and 1.6 gram of 1,6-hexanediol diacrylate (“SR238”) were mixed. 1.2 gram of difunctional alpha hydroxyketone (“ESACURE ONE”) as the photoinitiator and 18.0 grams of methyl isobutyl ketone were then added to the mixture. The mixture was adjusted to 40.0 wt. % in solids by adding 5.47 grams of 1-methoxy-2-propanol and the durable nanoporous coating precursor DNP-2 was provided.

### Preparation of Durable Nanoporous Coating Precursor (DNP-3)

26.15 grams of Sol-1, 48.57 grams of Sol-2, and 4.8 grams of trifunctional aliphatic urethane acrylate (“EBECERYL 8301”) and 1.2 gram of 1,6-hexanediol diacrylate (“SR238”) were mixed. 1.2 gram of difunctional alpha hydroxyketone (“ESACURE ONE”) as the photoinitiator and 18.0 grams of methyl isobutyl ketone were then added to the mixture. The mixture was adjusted to 40.0 wt. % in solids by adding 3.07 grams of 1-methoxy-2-propanol and the durable nanoporous coating precursor DNP-3 was provided.

### Preparation of Durable Nanoporous Coating Precursor (DNP-4)

27.69 grams of Sol-1, 51.43 grams of Sol-2, and 3.2 grams of trifunctional aliphatic urethane acrylate (“EBECERYL 8701”) and 1.6 gram of 1,6-hexanediol diacrylate (“SR238”) were mixed. 1.2 gram of difunctional alpha hydroxyketone (“ESACURE ONE”) as the photoinitiator and 18.0 grams of methyl isobutyl ketone were then added to the mixture. The mixture was adjusted to 40.0 wt. % in solids by adding 0.68 gram of 1-methoxy-2-propanol and the durable nanoporous coating precursor DNP-4 was provided.

### Preparation of Durable Nanoporous Coating Precursor (DNP-5)

27.69 grams of Sol-1, 51.43 grams of Sol-2, and 3.2 grams of trifunctional aliphatic urethane acrylate (“EBECERYL 8701”) and 1.6 gram of 1,6-hexanediol diacrylate (“SR238”) were mixed. 1.2 gram of difunctional alpha hydroxyketone (“ESACURE ONE”) as the photoinitiator and 18.0 grams of methyl isobutyl ketone were then added to the mixture. The mixture was adjusted to 40.0 wt. % in solids by adding 0.68 gram of 1-methoxy-2-propanol and the durable nanoporous coating precursor DNP-5 was provided.

### Preparation of Durable Nanoporous Coating Precursor (DNP-6)

26.15 grams of Sol-1, 48.57 grams of Sol-2, and 3.6 grams of trifunctional aliphatic urethane acrylate (“EBECERYL 8701”) and 1.2 gram of 1,6-hexanediol diacrylate (“SR238”) and 1.2 gram of methyl methacrylate copolymer (“PARALOID B-44”) were mixed. 1.2 gram of difunctional alpha hydroxyketone (“ESACURE ONE”) as the photoinitiator and 18.0 grams of methyl isobutyl ketone were then added to the mixture. The mixture was adjusted to 40.0 wt. % in solids by adding 3.07 grams of 1-methoxy-2-propanol and the durable nanoporous coating precursor DNP-6 was provided.

### Preparation of Durable Nanoporous Coating Precursor (DNP-7)

26.15 grams of Sol-1, 48.57 grams of Sol-2, and 3.6 grams of trifunctional aliphatic urethane acrylate (“EBECERYL 8701”) and 1.2 gram of 1,6-hexanediol diacrylate (“SR238”) and 1.2 gram of cellulose acetate butyrate (“CAB 381-20”) were mixed. 1.2 gram of difunctional alpha hydroxyketone (“ESACURE ONE”) as the photoinitiator and 18.0 grams of methyl isobutyl ketone were then added to the mixture. The mixture was adjusted to 40.0 wt. % in solids by adding 3.07 grams of 1-methoxy-2-propanol and the durable nanoporous coating precursor DNP-7 was provided.

### Comparative Examples A to F (CE-A to CE-F)

CE-A was a bare polyethylene terephthalate (PET) film with a thickness of 100 micrometers (obtained from Toray Industries, Inc., Tokyo, Japan, under trade designation “LUMIRROR U34”) was used as a substrate. No coating was applied. CE-B, CE-C and CE-D were each prepared by using the “LUMIRROR U34” film as a substrate and then forming a 3 micrometer thick hardcoat (i.e., 3-D printing surface) using HC-1, HC-2, and HC-3 respectively. The 3-D printing surfaces of CE-B, CE-C and CE-D were formed by Mayer Rod #8 and then drying for 5 minutes at 60° C. in the air. CE-E and CE-F were each prepared by using the “LUMIRROR U34” film as a substrate and then forming a 2.2 micrometer thick hardcoat (i.e., 3-D printing surface) using HC-4 and HC-5 respectively. The 3-D printing surfaces of CE-E and CE-F were formed using Mayer Rod #6 and then drying for 5 min at 60° C. in the air. The coated substrate was passed twice into UV irradiator (H-bulb (DRS model) from Heraeus Noblelight America, LLC., Gaithersburg, Md.) under nitrogen gas. During irradiation, 900 mJ/cm², 700 mW/cm² of ultraviolet (UV-A) was totally irradiated on the coated surface.

### Examples 1 to 7 (EX-1 to EX-7)

EX-1 to EX-7 were each prepared by using the “LUMIRROR U34” film as a substrate and then forming a 2.2 micrometer, 3 micrometer, 3 micrometer, 1.2 micrometer, 2.2 micrometer, 2.2 micrometer, and 2.2 micrometer thick 3-D durable nanoporous layer (i.e., 3-D printing surface) using DNP-1, DNP-2, DNP-3, DNP-4, DNP-5, DNP-6 and DNP-7 respectively. The 3-D printing surfaces of EX-1 to EX-7 were formed using Mayer Rod #6, #8, #8, #4, #6, #6 and #6, respectively. And then drying for 5 minutes at 60° C. in the air. The coated substrate was passed twice into UV irradiator (H-bulb (DRS model)) under nitrogen gas. During irradiation, 900 mJ/cm2, 700 mW/cm2 of ultraviolet (UV-A) was totally irradiated on the coated surface.

The resulting CE-A to CE-F and EX-1 to EX-7 3-D printing surface samples were tested using methods described above.

Table 1, below, summarizes evaluation results of 3-D printability for PLA for each of CE-A to CE-F and EX-1 to EX-7. 3-D molded article could not be fabricated on 3-D printing surface of CE-A to CE-F, as PLA thermoplastic could not be fixed on the surface. On the other hand, 3-D molded PLA articles were successfully fabricated on the surface of EX-1 to EX-7 which showed highly accurate three dimension article as rating “0” and good release ability. In addition EX-1 to EX-7 exhibited excellent steelwool abrasion resistance, deep scratches were hardly observed on the surface even after steelwool abrasion testing.

Table 2, below, summarizes evaluation results of 3-D printability for ABS. 3-D molded ABS article was successfully fabricated on the 3-D printing surfaces of EX-3 and EX-5 which also showed highly accurate three dimension article as rating “0” and good release ability.

TABLE 1

| | 3-D Printing ability for PLA | | | | Water | Initial Optical | | Optical Properties After Steel | | | |
|---|---|---|---|---|---|---|---|---|---|---|---|
| | Accuracy | Release | | Cross cut | contact | Properties | | Wool Abrasion Test | | | Scratch |
| Example | Rating | Ability | Delamination | Adhesion | angle | TT | Haze | TT | Haze | ΔHaze | Rating |
| CE-A | 4 | N/A | N/A | — | 69.40 | 92.35 | 0.67 | 93.15 | 15.08 | 14.41 | 4 |
| CE-B | 4 | N/A | N/A | 25/25 | 65.20 | 92.50 | 0.56 | 92.05 | 2.63 | 2.07 | 3 |
| CE-C | 4 | N/A | N/A | 25/25 | 73.10 | 92.28 | 0.64 | 93.11 | 0.92 | 0.28 | 2 |
| CE-D | 4 | N/A | N/A | 25/25 | 71.70 | 92.42 | 0.53 | 93.11 | 0.92 | 0.39 | 0 |
| CE-E | 3 | Light | No Delamination | 25/25 | 92.00 | 92.32 | 11.80 | 92.48 | 13.45 | 1.65 | 2 |
| CE-F | 3 | Super Light | No Delamination | 25/25 | 94.40 | 92.91 | 5.22 | 92.83 | 7.24 | 2.02 | 2 |
| EX-1 | 1 | Good | No Delamination | 25/25 | 83.70 | 92.36 | 8.03 | 92.39 | 8.88 | 0.85 | 1 |
| EX-2 | 0 | Good | Partial Delamination | 25/25 | 49.70 | 93.15 | 57.51 | 93.08 | 57.04 | −0.47 | 0 |
| EX-3 | 0 | Good | No Delamination | 25/25 | 87.60 | 92.52 | 24.28 | 92.51 | 24.68 | 0.40 | 0 |
| EX-4 | 0 | Good | No Delamination | 25/25 | 75.10 | 91.72 | 6.85 | 91.72 | 5.95 | −0.90 | 1 |
| EX-5 | 0 | Good | No Delamination | 25/25 | 87.70 | 90.33 | 9.00 | 90.29 | 9.49 | 0.49 | 1 |
| EX-6 | 0 | Good | No Delamination | 25/25 | 86.00 | 92.85 | 8.46 | 92.84 | 8.37 | −0.09 | 1 |
| EX-7 | 0 | Good | No Delamination | 25/25 | 94.60 | 96.45 | 52.96 | 96.47 | 52.20 | −0.76 | 1 |

TABLE 2

| | | | | | | Initial | | Optical Properties | | | |
|---|---|---|---|---|---|---|---|---|---|---|---|
| | 3-D Printing ability for ABS | | | | Water | Optical | | After Steel Wool | | | |
| | Accuracy | Release | | Cross cut | contact | Properties | | Abrasion Test | | | Scratch |
| Example | Rating | Ability | Delamination | Adhesion | angle | TT | Haze | TT | Haze | [symbol] Haze | Rating |
| EX-3 | 0 | Good | No | 25/25 | 87.6 | 92.52 | 24.28 | 92.51 | 24.68 | 0.40 | 0 |
| | | | Delamination | | | | | | | | |
| EX-5 | 0 | Good | No | 25/25 | 87.7 | 90.33 | 9.00 | 90.29 | 9.49 | 0.49 | 1 |
| | | | Delamination | | | | | | | | |

Foreseeable modifications and alterations of this disclosure will be apparent to those skilled in the art without departing from the scope and spirit of this invention. This invention should not be restricted to the embodiments that are set forth in this application for illustrative purposes.

1. A method of three-dimensionally printing an article, the method comprising:
providing a surface comprising a composition, the composition comprising:
(i) a binder, and
(ii) a mixture of nanoparticles in a range from 80 wt. % to 99.9 wt. %, based on the total weight of the composition, wherein 10 wt. % to 50 wt. % of the nanoparticles have an average particle diameter in a range from 2 nm to 200 nm and 50 wt. % to 90 wt. % of the nanoparticles have an average particle diameter in a range from 60 nm to 400 nm, and wherein the ratio of average particle diameters of nanoparticles having an average particle diameter in the range from 2 nm to 200 nm to average particle diameters of nanoparticles having an average particle diameter in the range from 60 nm to 400 nm is in a range from 1:1 to 1:200; and
three-dimensionally printing the article onto the surface.

2. The method of claim 1, wherein the nanoparticles include modified nanoparticles.

3. The method of claim 1, wherein the mixture of nanoparticles is in a range of from 85 wt. % to 95 wt. %, based on the total weight of the composition.

4. The method of claim 1, wherein the surface has a [symbol] haze in range from −1.0 to 1.0 as determined by the Haze Test.

5. The method of claim 1, wherein the article has an accuracy rating of not greater than 1 as determined by the 3-D Printing Accuracy Test.

6. The method of claim 1, wherein the surface has a less than 100 degree of water contact angle.

7. The method of claim 1, wherein the surface has a greater than 8 nm of surface roughness as determined by atomic force microscopy.

8. The method of claim 1 further comprising curing reactive resin to provide the binder.

9. The method of claim 1 further comprising curing radical reactive acrylate to provide the binder.

10. The method of claim 1 further comprising curing a mixture comprising in a range from 80 wt. % to 90 wt. % radical reactive acrylate and 20 wt. % to 10 wt. % of non-radical reactive acrylate, based on the total weight of the mixture, to provide the binder.

11. The method of claim 7, wherein the curing includes actinic radiation.

12. The method of claim 1 further comprising plasma treating the surface prior to three-dimensionally printing the article onto the surface.
